(19) United States
(12) Patent Application Publication
(10) Pub. No.: US 2010/0278354 A1
(43) Pub. Date: Nov. 4, 2010

(54) VOICE RECORDING METHOD, DIGITAL PROCESSOR AND MICROPHONE ARRAY SYSTEM

(75) Inventors: Li-Te Wu, Taipei (TW); Ssu-Ying Chen, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/433,932

(22) Filed: May 1, 2009

(51) Int. Cl. H04B 15/00

(52) U.S. Cl. 381/94.2

(57) ABSTRACT

A microphone array system and a method implemented therefore are provided. A first microphone having a first sensibility receives a sound source to generate a first signal. A second microphone is deposited at a distance from the first microphone, having a second sensibility for receiving the sound source to generate a second signal. A comparator subtracts the first signal and the second signal to generate a difference signal. An analyzer estimates an incident angle of the sound source to determine a compensation factor based on the first signal and the difference signal. A gain stage adjusts a gain of the difference signal based on the compensation factor to output an output signal.

### BACKGROUND OF THE INVENTION

1. Field of the Invention

The invention relates to a close talking microphone array (CTMA) system, and in particular, to a voice recording method implemented in a digital processor for the CTMA system.

2. Description of the Related Art

Noise suppression in a noisy environment is a general concern for voice recording applications. The close talking microphone array (CTMA) is therefore provided as an efficient solution to enhance the quality of received voice signals.

FIGS. 1a and 1b show microphone arrangements of conventional CTMA systems. In FIG. 1a, a first microphone 102 and a second microphone 104 are arranged side by side with a distance D. A sound source S is presented at a distance r₁ to the first microphone 102 while at a distance r₂ to the second microphone 104. An incident angle is defined as an angle between a line segment from node S to node M and a line L extended from the first microphone 102 to the second microphone 104, where the node M is a center point between the first microphone 102 and the second microphone 104. The line segment from node S to node M has a distance r. The first microphone 102 and second microphone 104 are typically omni microphones having voice sensibility inverse proportional to the square of the distances r₁ and r₂, respectively. However, according to the nature of differential signals, a CTMA formed by the first microphone 102 and second microphone 104 has a sensibility inverse proportional to quadruplicate of the distance r. In this way, the environmental noise at a distance is rapidly suppressed, allowing a near end voice signal to be efficiently received.

FIG. 1b shows a back to back architecture of the CTMA system. Like the architecture of FIG. 1a, the sound source S forms an incident angle with the line L extended from the first microphone 102 to the second microphone 104. Conventionally, the incident angle is a parameter that affects output gain of the received voice signal. When the incident angle of a dot sound source is 90 degrees or 270 degrees, the output from the first microphone 102 and second microphone 104 will cancel each other out and cause the output gain to be undesirably degraded. Although, practically, it is impossible to find a dot sound source because of the wave propagation law, the incident angle does affect the efficiency of voice recording. Thus, it is desirable to find a solution to mitigate the incident angle issue.

### BRIEF SUMMARY OF THE INVENTION

An exemplary embodiment of a microphone array system is provided. A first microphone having a first sensibility receives a sound source to generate a first signal. A second microphone is deposited at a distance from the first microphone, having a second sensibility for receiving the sound source to generate a second signal. A comparator subtracts the first signal and the second signal to generate a difference signal. An analyzer estimates an incident angle of the sound source to determine a compensation factor based on the first signal and the difference signal. A gain stage adjusts a gain of the difference signal based on the compensation factor to output an output signal.

Another embodiment is a voice recording method implemented on the microphone array system is provided. A first microphone having a first sensibility is provided to receive a sound source to generate a first signal. A second microphone is deposited at a distance from the first microphone, having a second sensibility to receive the sound source to generate a second signal. The first signal is subtracted by the second signal to generate a difference signal. An incident angle of the sound source is estimated to determine a compensation factor based on the first signal and the difference signal. A gain of the difference signal is adjusted based on the compensation factor to generate a output signal. A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1a and 1b show microphone arrangements of conventional CTMA systems;

FIGS. 2a to 2d show embodiments of microphone array systems according to the invention;

FIG. 3 shows an embodiment of an analyzer 210 according to the invention;

FIG. 4a is a flowchart of a voice recording method based on the microphone array systems of FIGS. 2a to 2d;

FIG. 4b is flowchart of the incident angle estimation performed by the analyzer 210; and

FIG. 5 shows an embodiment of a 500 adaptable for analog microphones.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

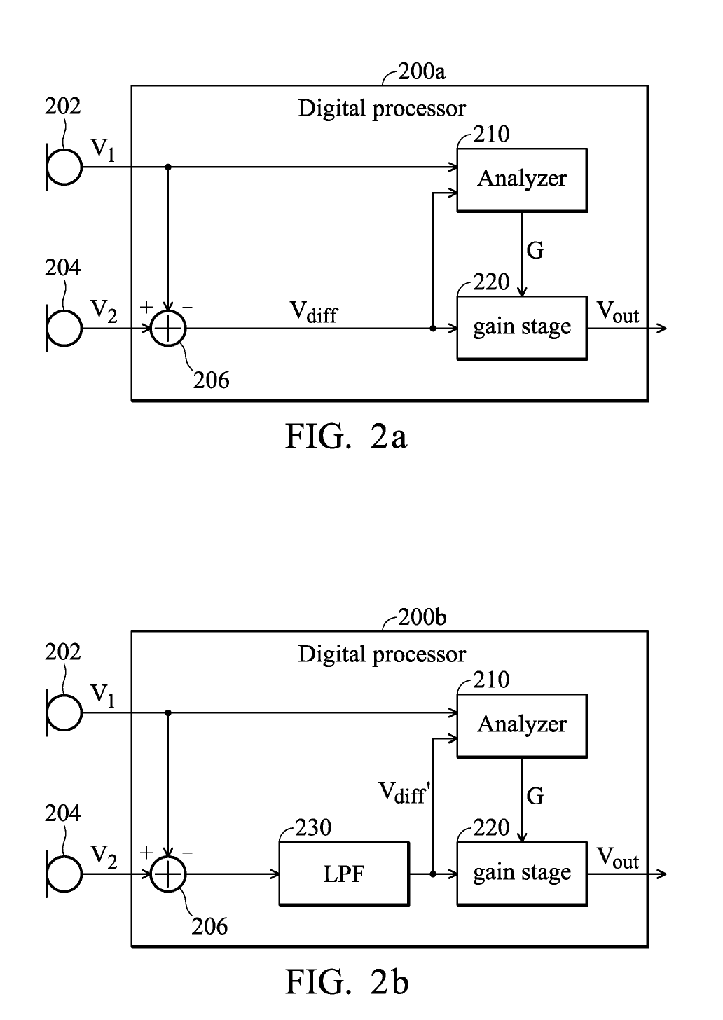

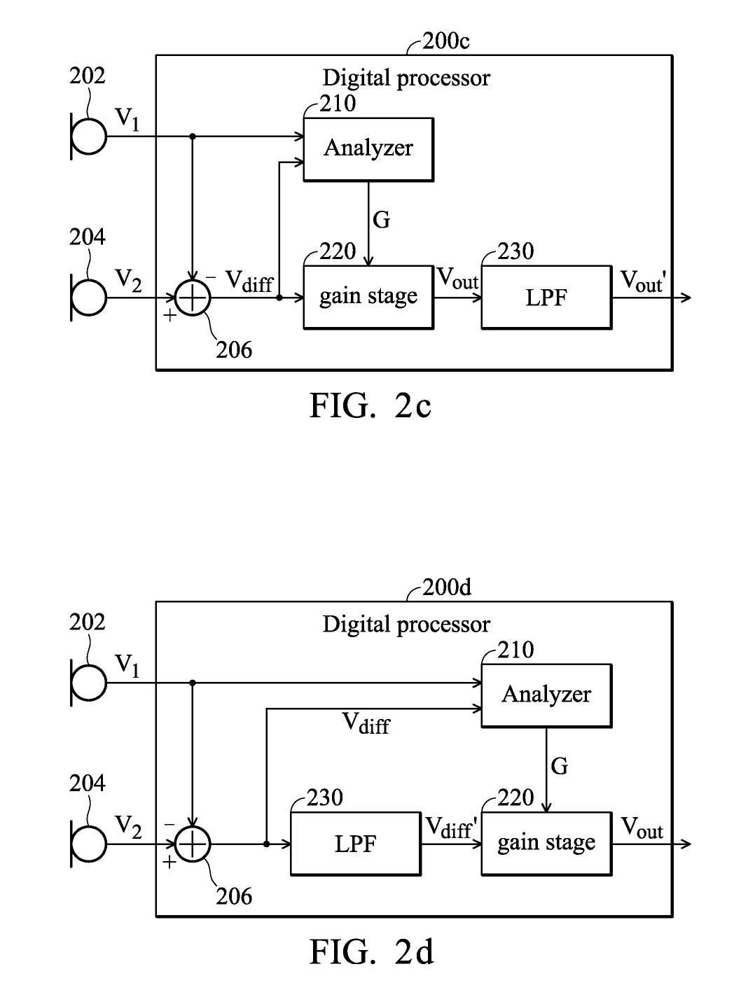

FIGS. 2a to 2d show embodiments of microphone array systems according to the invention. An analyzer 210 and a gain stage 220 are provided to cooperatively mitigate the incident angle issue. Detailed embodiments are described below.

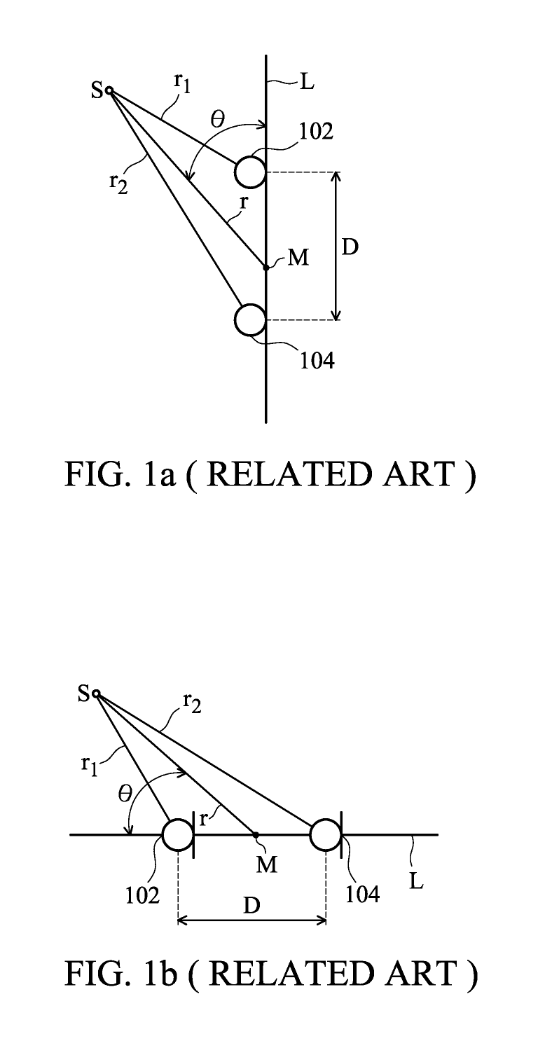

In FIG. 2a, a first microphone 202 and a second microphone 204 are presented, deposited as shown in either FIG. 1a or FIG. 1b. The first microphone 202 may have a first sensibility S₁, and a sound source at a distance as shown in either FIG. 1a or FIG. 1b may induce a first signal V₁ on the first microphone 202. The first signal V₁ is shown in the following equation:

$${V}_{1} = {S}_{1} {P}_{1} = {S}_{1} \frac{A ( k ) {e}^{- j {kr}_{1}}}{{r}_{1}} , \qquad ( 1 )$$

where S₁ denotes sensibility of the first microphone 202, A(k) denotes sound pressure of a wave number k, and

$${P}_{1} = \frac{A ( k ) {e}^{- j {kr}_{1}}}{{r}_{1}}$$

denotes the sound pressure received by the first microphone 202 with a distance r₁ from the sound source.

Likewise, the second signal V₂ received by the second microphone 204 is shown in the following equation:

$${V}_{2} = {S}_{2} {P}_{2} = {S}_{2} \frac{A ( k ) {e}^{- j {kr}_{2}}}{{r}_{2}} , \qquad ( 2 )$$

where the sensitivity of the second microphone 204 is S₂ (S₁=S₂=S), and the distance from the sound source is r₂.

As shown in FIG. 2a and below, a digital processor 200a is attached to the first microphone 202 and the second microphone 204, in which a comparator 206, an analyzer 210 and a gain state 220 are presented. The digital processor 200a is generally implemented as an integrated circuit chip, whereas the microphones 202 and 204 are typically external devices attachable to the digital processor 200a through certain interfaces (not shown).

The comparator 206 subtracts the first signal V₁ and the second signal V₂ to generate a difference signal V_{diff}:

$$\begin{matrix}{V}_{diff} = {V}_{2} - {V}_{1} \\ = S \cdot A ( k ) \cdot [ \frac{{e}^{- j {kr}_{2}}}{{r}_{2}} - \frac{{e}^{- j {kr}_{1}}}{{r}_{1}} ] \\ \approx S \cdot A ( k ) \cdot \frac{{e}^{- j kr}}{r} ( \frac{1 + j kr}{r} ) D cos θ ,\end{matrix} \qquad ( 3 )$$

where k is wave number defined as

$$k ≡ \frac{2 π f}{c} ,$$

D denotes the distance between the first microphone 202 and the second microphone 204, Θ is the incident angle, and c denotes the sound speed. Note that the difference signal V_{diff} in equation (3) is approximated for brevity since the distances r₁ and rₜ are very close to r.

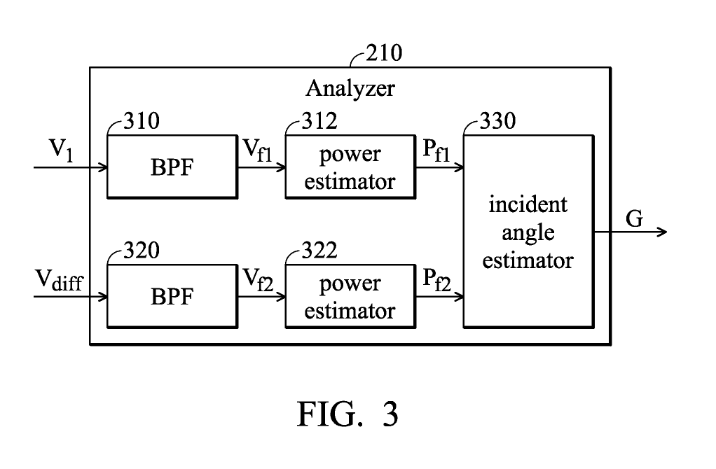

The first signal V₁ and the difference signal V_{diff} are then output to an analyzer 210, whereby the incident angle is estimated. Furthermore, a compensation factor G for compensating for the incident angle effect is then determined based on the first signal V₁ and the difference signal V_{diff}. Detailed estimation of the incident angle will be described in FIG. 3. Eventually, the gain of the difference signal V_{diff} is adjusted by a gain stage 220 based on the compensation factor G to output an output signal Vₒᵤₜ, in which the incident angle effect is mitigated.

According to equation (3), the frequency response of the difference signal V_{diff} behaves like a high pass filter. In order to suppress the high frequency emphasis, an LPF 230 (also called deemphasis filter) is required. FIGS. 2b, 2c and 2d show various embodiments with different deposition of the LPF 230.

In FIG. 2b, a LPF 230 is implemented in the digital processor 200b, coupled to the comparator 206 for low pass filtering the difference signal V_{diff} before the difference signal V_{diff} is sent to the analyzer 210 and gain stage 220. The transfer function of the LPF 230 is defined as:

$${H}_{LPF} = \frac{1}{D} \cdot \frac{{r}_{0}}{1 + s ( \frac{{r}_{0}}{c} )} , \qquad ( 4 )$$

where s=j·2πf, and thus the filtered difference signal V_{diff′} output from the LPF 230 is represented as:

$$\begin{matrix}{V}_{diff}^{′} = {V}_{diff} \cdot {H}_{LPF} \\ = S \cdot A ( k ) \cdot \frac{{e}^{- j kr}}{r} cos θ \cdot \frac{{r}_{0}}{r} \cdot \frac{1 + s ( \frac{r}{c} )}{1 + s ( \frac{{r}_{0}}{c} )} .\end{matrix} \qquad ( 5 )$$

The LPF 230 comprises a pole frequency and a zero frequency. The pole frequency and the zero frequency are respectively defined as:

$$\begin{matrix}{F}_{pole} = \frac{c}{2 π {r}_{0}} ; and & ( 6 ) \\ {F}_{zero} = \frac{c}{2 π r} , & ( 7 )\end{matrix}$$

Where r₀ is a chosen value to render a pole frequency of subsequently 1.5 KHz. As the filtered difference signal V_{diff′} is generated, the analyzer 210 and gain stage 220 then perform the compensation based therein, which will be described in the embodiment of FIG. 3.

FIG. 2c shows an alternative deployment of the LPF 230. In a digital processor 200c, the LPF 230 may be implemented on the output end of the gain stage 220, performing the low pass filtering after the output signal Vₒᵤₜ is generated. Since the system is linear, a filtered result filtered output Vₒᵤₜ′ should be identical to the output signal Vₒᵤₜ of the embodiment of FIG. 2b.

FIG. 2d shows a further embodiment of the microphone system. A LPF 230 in the digital processor 200d is coupled to the output end of the comparator 206, low pass filtering the difference signal V_{diff} to generate a filtered difference signal V_{diff′}. However, the compensation factor G determined by the analyzer 210 is based on the first signal V₁ and the difference signal V_{diff}, while the output signal Vₒᵤₜ is generated from the filtered difference signal V_{diff′} which is adjusted based on the compensation factor G.

FIG. 3 shows an embodiment of an analyzer 210 according to the invention. If the analyzer 210 is adapted in the embodiments of FIGS. 2a, 2c and 2d, the first signal V₁ and the difference signal V_{diff} are input to determine the compensation factor G. Meanwhile, if the analyzer 210 is adapted in the embodiment of FIG. 2b, the filtered difference signal V_{diff′} is used instead of the difference signal V_{diff} to determine the compensation factor G. Since the process is linear no matter where the LPF 230 is deposited, FIG. 2b is adapted as an example to explain the functionality of the analyzer 210.

In the analyzer 210, a first BPF 310 filters the first signal V₁ with a center frequency F_{c} to generate a first band passed signal V_{f1} since r₁≅r:

$${V}_{f 1} = S ( {F}_{C} ) \cdot A ( {F}_{C} ) \frac{{e}^{- 2 π {F}_{C} \frac{r}{c}}}{r} , \qquad ( 8 )$$

where S(F_{C}) denotes a sensitivity function correlated to the center frequency F_{C}, and A(F_{C}) denotes an amplitude function correlated to the center frequency F_{C}. Since the mathematics in a BPF is a known technology, detailed explanation is omitted herein.

In the embodiment, the center frequency is chosen to be 3 KHz. Likewise, a second BPF 320 band pass filters the difference signal V_{diff} with the center frequency F_{c} to generate a second band passed signal V_{f2} since

$$1 < 2 π f \frac{{r}_{0}}{c} :$$

$$\begin{matrix}{V}_{f 2} = S ( {F}_{C} ) \cdot A ( {F}_{C} ) \frac{{e}^{- 2 π {F}_{C} \frac{r}{c}}}{r} cos θ \cdot \frac{{r}_{0}}{r} \cdot \frac{1 + s ( \frac{r}{c} )}{1 + s ( \frac{{r}_{0}}{c} )} \\ ≅ S ( {F}_{C} ) \cdot A ( {F}_{C} ) \frac{{e}^{- 2 π {F}_{C} \frac{r}{c}}}{r} cos θ .\end{matrix} \qquad ( 9 )$$

A first power estimator 312 is coupled to the first BPF 310, determining a first power level p_{f1} of the first band passed signal V_{f1}, as shown as follows:

P_{f1}=|V_{f1}|²=S²(F_{C})·A²(F_{C}) (10).

Meanwhile, a second power estimator 322 determines a second power level P_{f2} of the second band passed signal V_{f2}:

P_{f2}=|V_{f2}|²=S²(F_{C})·A²(F_{C})cos² θ (11).

Based on equations (10) and (11), an incident angle estimator 330 can calculate a cosine function of the incident angle as follows:

$$cos θ = \sqrt{\frac{{P}_{f 2}}{{P}_{f 1}}} . \qquad ( 13 )$$

Since the incident angle effect is dependent on the cosine function of the incident angle, a compensation factor G, with an inverse proportional value, may be used to compensate for the incident angle effect may be employed:

$$G = \frac{1}{cos θ} = \sqrt{\frac{{P}_{f 1}}{{P}_{f 2}}} . \qquad ( 14 )$$

Consequently, the compensation factor G is sent to the gain stage 220, and the gain stage 220 adjusts the gain of the difference signal V_{diff} by multiplying the difference signal V_{diff} by the compensation factor G, such that the output signal Vₒᵤₜ is generated as shown below:

$${V}_{out} = G \cdot {V}_{diff} = S \cdot A ( k ) \cdot \frac{{e}^{- j kr}}{r} \cdot \frac{{r}_{0}}{r} \cdot \frac{1 + s ( \frac{r}{c} )}{1 + s ( \frac{{r}_{0}}{c} )} . \qquad ( 15 )$$

As shown in equation (15), the dependency of the incident angle is fully eliminated. The main characteristics of equation (15) can be tuned by carefully selecting the parameter r₀ and wave number k. Practically, the gain stage 220 can be a multiplier simply performing a multiplication operation on the difference signal V_{diff} and the compensation factor G.

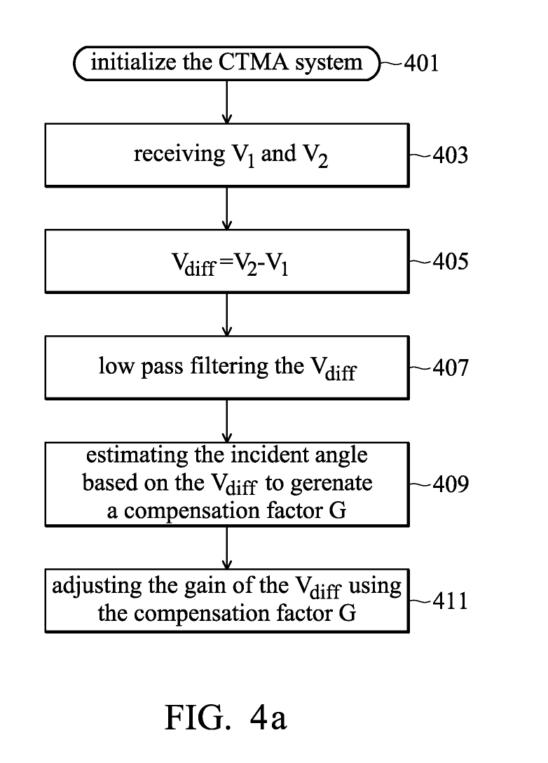

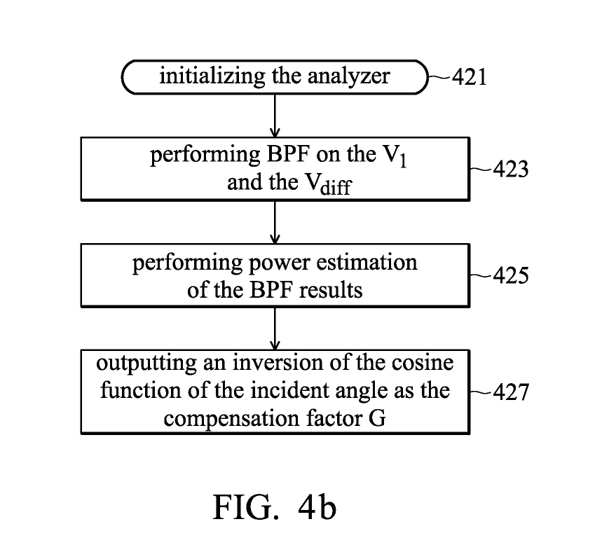

FIG. 4a is a flowchart of a voice recording method based on the microphone array systems of FIGS. 2a to 2d. The steps can be summarized as follows. In step 401, the close talking microphone array (CTMA) system is initialized. In step 403, a first signal V₁ and a second signal V₂ are generated respectively from the first microphone 202 and the second microphone 204. In step 405, the comparator 206 subtracts the second signal V₂ by the first signal V₁ to generate a difference signal V_{diff}. In step 407, low pass filtering is performed. As described, step 407 is optional, and can be implemented in various places of the data path. FIG. 2b is used as an example, wherein a filtered difference signal V_{diff′} is generated and sent to the analyzer 210 and gain stage 220. In step 409, the analyzer 210 estimates the incident angle based on the first signal V₁ and the filtered difference signal V_{diff′}, and then outputs a compensation factor G for compensating for incident angle effect based on the estimate incident angle. In step 411, the gain stage 220 receives the compensation factor G and the filtered difference signal V_{diff′}, and performs a multiplication operation to output an output signal Vₒᵤₜ which is uninfluenced by the incident angle.

FIG. 4b is a flowchart of the incident angle estimation performed by the analyzer 210. The process performed by the analyzer 210 can be summarized in the following steps. In step 421, the analyzer 210 is initialized to receive the first signal V₁ and the difference signal V_{diff} (or filtered difference signal V_{diff′}). In step 423, the band pass filters are utilized to cleanse the first signal V₁ and the difference signal V_{diff} (or filtered difference signal V_{diff′}), thus the first band passed signal V_{f1} and second band passed signal V_{f2} are respectively generated. In step 425, power estimation is processed on the first band passed signal V_{f1} and second band passed signal V. The first power estimator 312 and second power estimator 322 can implement square functions to obtain the first power level p_{f1} and second power level P. With the first power level P_{f1} and second power level P_{f2} are obtained, the cosine function of the incident angle can be acquired, and in step 427, the compensation factor G is output as an inversion of the cosine function of the incident angle. The compensation factor G is then used by the gain stage 220 to generate an incident angle independent output signal Vₒᵤₜ.

The embodiments in FIGS. 2a to 2d are adaptable for either analog microphones or digital microphones. The digital processors 200a to 200d are typically operative in digital domains, thus the signals must be digitalized before inputting to the digital processors 200a to 200d. For example, the microphones 202 and 204 are digital microphones, and their outputs are digital signals, thus the successive operations can be processed in the digital processors 200a to 200d. Conversely, if the microphones 202 and 204 are analog microphones, analog to digital converters (ADCs) are required.

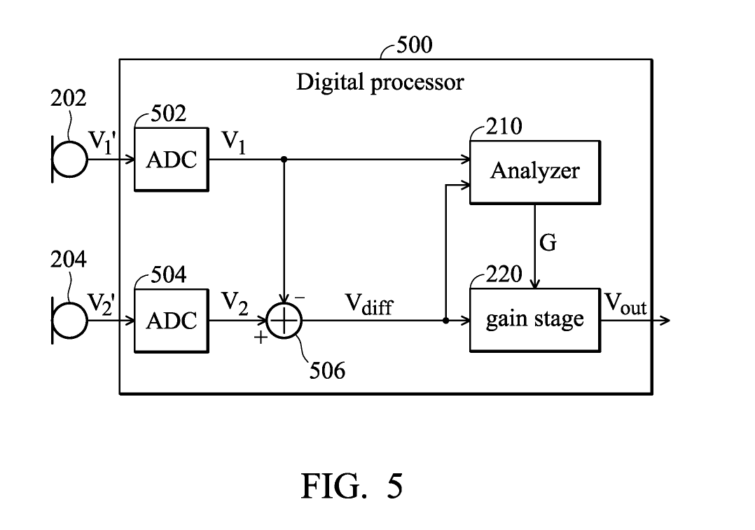

FIG. 5 shows a further embodiment of a digital processor 500, particularly adaptable for analog microphones. In FIG. 5, the microphones 202 and 204 are analog microphones receiving voice to output analog signals V₁′ and V₂′. Two ADCs 502 and 504 are respectively implemented in the digital processor 500, for digitizing the analog outputs V₁′ and V₂′ from the microphones 202 and 204 to generate the first signal V₁ and the second signal V₂. Thus, the first and second signals are digital signals, and the analyzer 210 and gain stage 220 are operative in digital domains. The ADCs 502 and 504 can also be implemented in the embodiments of FIGS. 2b, 2c and 2d to extend the processing capability of the digital processors 200b, 200c and 20d, thus redundant descriptions are omitted herein.

In comparison with conventional omni microphones, the CTMA system performs better noise suppression for low frequency signals. Background noise is typically defined as voices at a distance longer than one meter. Since dependency on the incident angle is eliminated, the embodiment is particularly adaptable in mobile communication applications such as cell phones or walkmans. The microphones on the CTMA system can be arranged either side by side or back to back. The pole frequency of the low pass filter can be tuned to exhibit better performance, thus the invention is not limit thereto.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microphone array system comprising:
a first microphone, having a first sensibility and receiving a sound source to generate a first signal;
a second microphone, deposited at a distance from the first microphone, having a second sensibility and receiving the sound source to generate a second signal; and
a digital processor attached to the first microphone and the second microphone, comprising:
a comparator, subtracting the first signal and the second signal to generate a difference signal;
an analyzer, coupled to the first microphone and the comparator, estimating an incident angle of the sound source to determine a compensation factor based on the first signal and the difference signal; and
a gain stage, coupled to the analyzer and the comparator, adjusting a gain of the difference signal based on the compensation factor to output an output signal.

2. The microphone array system as claimed in claim 1, wherein the digital processor further comprises a low pass filter (LPF), coupled to the comparator, for low pass filtering the difference signal before the difference signal is sent to the analyzer and the gain stage.

3. The microphone array system as claimed in claim 1, wherein the digital processor further comprises an LPF, coupled to the output end of the gain stage, low pass filtering the output signal to generate a filtered output.

4. The microphone array system as claimed in claim 1, wherein:
the digital processor further comprises an LPF, coupled to the comparator, low pass filtering the difference signal to generate a filtered difference signal;
the analyzer determines the compensation factor based on the first signal and the difference signal; and
the gain stage adjusts the gain of the filtered difference signal based on the compensation factor to generate the output signal.

5. The microphone array system as claimed in claim 1, wherein the analyzer comprises:
a first band pass filter (BPF), band pass filtering the first signal with a center frequency to generate a first band passed signal;
a first power estimator, coupled to the first BPF, receiving the first band passed signal to determine a first power level of the first band passed signal;
a second BPF, band pass filtering the difference signal with the center frequency to generate a second band passed signal;
a second power estimator, coupled to the second BPF, receiving the second band passed signal to determine a second power level of the second band passed signal;
an incident angle estimator, coupled to the first power estimator and the second power estimator, calculating the incident angle based on the first band passed signal and second band passed signal; wherein the compensation factor is inverse proportional to a cosine function of the incident angle.

6. The microphone array system as claimed in claim 5, wherein the incident angle estimator calculates the cosine function of the incident angle by dividing the second power level by the first power level.

7. The microphone array system as claimed in claim 5, wherein the center frequency is 3 KHz.

8. The microphone array system as claimed in claim 1, wherein the first microphone and second microphone are arranged side by side, and the incident angle is an angle between the sound source and a line extended from the first microphone to the second microphone.

9. The microphone array system as claimed in claim 1, wherein the first microphone and second microphone are arranged back to back, and the incident angle is an angle between the sound source and a line extended from the first microphone to the second microphone.

10. The microphone array system as claimed in claim 1, wherein the gain stage adjusts the gain of the difference signal by multiplying the difference signal by the compensation factor, such that the output signal is generated.

11. The microphone array system as claimed in claim 1, wherein the first microphone and the second microphone are analog microphones, and the digital processor further comprises:
a first analog to digital converter (ADC) attached to the first microphone, digitizing analog outputs from the first microphone to generate the first signal; and
a second ADC attached to the second microphone, digitizing analog outputs from the second microphone to generate the second signal.

12. The microphone array system as claimed in claim 1, wherein the first microphone and the second microphone are digital microphones, and the first and second signals are digital signals.

13. A voice recording method for a microphone array system, comprising:
providing a first microphone having a first sensibility to receive a sound source to generate a first signal;
providing a second microphone deposited at a distance from the first microphone, having a second sensibility to receive the sound source to generate a second signal;
subtracting the first signal and the second signal to generate a difference signal;
estimating an incident angle of the sound source to determine a compensation factor based on the first signal and the difference signal;
adjusting a gain of the difference signal based on the compensation factor to generate a output signal.

14. The voice recording method as claimed in claim 13, further comprising low pass filtering the difference signal before the estimating step and the adjusting step.

15. The voice recording method as claimed in claim 13, further comprising low pass filtering the output signal to generate a filtered output.

16. The voice recording method as claimed in claim 13, further comprising:
low pass filtering the difference signal to generate a filtered difference signal;
determining the compensation factor based on the first signal and the difference signal; and
adjusting the gain of the filtered difference signal based on the compensation factor to generate the output signal.

17. The voice recording method as claimed in claim 13, wherein the estimation of the incident angle comprises:
band pass filtering the first signal with a center frequency to generate a first band passed signal;
determining a first power level of the first band passed signal;
band pass filtering the difference signal with the center frequency to generate a second band passed signal;
determining a second power level of the second band passed signal; and
calculating the incident angle based on the first band passed signal and second band passed signal, wherein the compensation factor is inverse proportional to a cosine function of the incident angle.

18. The voice recording method as claimed in claim 17, wherein calculation of the incident angle comprises calculating the cosine function of the incident angle by dividing the second power level by the first power level.

19. The voice recording method as claimed in claim 17, wherein the center frequency is 3 KHz.

20. The voice recording method as claimed in claim 13, wherein the first microphone and second microphone are arranged side by side, and the incident angle is an angle between the sound source and a line extended from the first microphone to the second microphone.

21. The voice recording method as claimed in claim 13, wherein the first microphone and second microphone are arranged back to back, and the incident angle is an angle between the sound source and a line extended from the first microphone to the second microphone.

22. The voice recording method as claimed in claim 13, wherein generation of the output signal comprises multiplying the difference signal by the compensation factor to generate the output signal.

23. The voice recording method as claimed in claim 13, wherein the first microphone and the second microphone are analog microphones, and the voice recording method further comprises:
digitizing analog outputs from the first microphone to generate the first signal; and
digitizing analog outputs from the second microphone to generate the second signal.

24. The voice recording method as claimed in claim 13, wherein the first microphone and the second microphone are digital microphones, and the first and second signals are digital signals.

25. A digital processor, attachable to a microphone array comprising a first microphone and a second microphone, wherein the first microphone has a first sensibility for receiving a sound source to generate a first signal, and the second microphone is deposited at a distance from the first microphone, having a second sensibility for receiving the sound source to generate a second signal, the digital processor comprising:
a comparator, subtracting the second signal by the first signal to generate a difference signal;
an analyzer, coupled to the first microphone and the comparator, estimating an incident angle of the sound source to determine a compensation factor based on the first signal and the difference signal;
a gain stage, coupled to the analyzer and the comparator, adjusting a gain of the difference signal based on the compensation factor to output an output signal.

26. The digital processor as claimed in claim 25, further comprising a low pass filter (LPF), coupled to the comparator, for low pass filtering the difference signal before the difference signal is sent to the analyzer and the gain stage.

27. The digital processor as claimed in claim 25, further comprising an LPF, coupled to the output end of the gain stage, low pass filtering the output signal to generate a filtered output.

28. The digital processor as claimed in claim 25, further comprising an LPF, coupled to the comparator, low pass filtering the difference signal to generate a filtered difference signal, wherein:
the compensation factor is determined based on the formula
$$G = \frac{1}{cos θ} ,$$
where G denotes the compensation factor and Θ denotes the incident angle;
the gain stage adjusts the gain of the filtered difference signal based on the compensation factor to generate the output signal.

29. The digital processor as claimed in claim 25, wherein the analyzer comprises:
a first band pass filter (BPF), band pass filtering the first signal with a center frequency to generate a first band passed signal denoted as V_{f1};
a first power estimator, coupled to the first BPF, receiving the first band passed signal to determine a first power level of the first band passed signal based on the formulae P_{f1}=|V_{f1}|², where P_{f1} denotes the first power level;
a second BPF, band pass filtering the difference signal with the center frequency to generate a second band passed signal denoted as V_{f2};
a second power estimator, coupled to the second BPF, receiving the second band passed signal to determine a second power level of the second band passed signal based on the formulae P_{f2}=|V_{f2}|², where P_{f2} denotes the second power level;
an incident angle estimator, coupled to the first power estimator and the second power estimator, calculating the incident angle based on a formulae
$$cos θ = \sqrt{\frac{{P}_{f 2}}{{P}_{f 1}}} .$$

30. The digital processor as claimed in claim 29, wherein the center frequency is 3 KHz.

31. The digital processor as claimed in claim 25, wherein the first microphone and second microphone are arranged side by side, and the incident angle is an angle between the sound source and a line extended from the first microphone to the second microphone.

32. The digital processor as claimed in claim 25, wherein the first microphone and second microphone are arranged back to back, and the incident angle is an angle between the sound source and a line extended from the first microphone to the second microphone.

33. The digital processor as claimed in claim 25, wherein the gain stage adjusts the gain of the difference signal based on a formulae Vₒᵤₜ=G·V_{diff}, where G denotes the compensation factor, Vₒᵤₜ is the output signal, and V_{diff} is the difference signal.

34. The digital processor as claimed in claim 25, wherein the first microphone and the second microphone are analog microphones, and the digital processor further comprises:
a first analog to digital converter (ADC), attachable to the first microphone, digitizing an output of the first microphone to generate the first signal; and
a second ADC, attachable to the second microphone, digitizing an output of the second microphone to generate the second signal.

35. The digital processor as claimed in claim 25, wherein the first microphone and the second microphone are digital microphones, and the first and second signals are digital signals.
